(19) United States
(12) Patent Application Publication
(10) Pub. No.: US 2010/0110608 A1
(43) Pub. Date: May 6, 2010

(54) Core-shell structured dielectric particles for use in multilayer ceramic capacitors

(76) Inventors: Frank Wei, Valencia, CA (US); Ian Burn, Hockessin, DE (US)

Correspondence Address: Mr. Frank Wei, 26135 Quartz Mesa Lane, Valencia, CA, 91381, US

(21) Appl. No.: 12/291,153

(22) Filed: Nov. 6, 2008

(51) Int. Cl. H01G 4/06

(52) U.S. Cl. 361/321.4

(57) ABSTRACT

This invention provides a method to make core-shell structured dielectric particles which consist of a conductive core and at least one layer of insulating dielectric shell for the application of multilayer ceramic capacitors (MLCC). The use of said core-shell instead of conventionally solid dielectric particles as the capacitor's active layers simplifies the MLCC manufacturing processes and effectively improves the MLCC properties. In particular, the use of core-shell particles with a thin shell of high permittivity dielectric material improves the capacitance volumetric efficiency, and the use of core-shell particles with a thick shell of dielectric will improve capacitor device's energy storage capacity as the results of improved electrical and mechanical strength.

### OTHER PUBLICATIONS

CROSS-REFERENCE TO RELATED APPLICATIONS
U.S. patent documents

| | | | |
|---|---|---|---|
| 4,324,750 | April 1982 | Maher | 264/61 |
| 4,419,310 | June 1983 | Burn | 264/59 |
| 5,545,184 | August 1996 | Dougherty | 607/5 |
| 5,835,338 | October 1996 | Suzuki | 361/301 |
| 6,292,355 | July 1991 | Kang | 361/321 |

J. M. Herbert, “Ceramic Dielectrics and Capacitors,” Gordon and Breach Science Publishers, 1992.
“The ARRL handbook for Radio Amateurs”, 79^{th} edition, published by the National Association for Amateur Radio, 2002.
G. Goodman “Capacitors Based on Ceramic Grain Boundary Barrier Layer—a Review” Advanced in Ceramics, Vol. 1, p215-231,1981
M. Fujimoto and W. D. Kingery, “Microstructure of SrTiO₃ internal Boundary Layer Capacitors During and After Processing and Resultant Electrical Properties”, J. Am. Ceram. Soc., 68, [4], p 169-173, 1985.
B. W. Lee and K. H. Auh, “Effect of grain size and mechanical processing on the dielectric properties of BaTiO₃”, J. Mater. Res, Vol. 10, No. 6, June 1995, p. 1418 Takeshi Nomura, “Overview and Subject of Large Capacitance Multilayer Ceramic Capacitors,” Ceramics, Vol. 36 (2001) p. 394.
Reji Thomas et al, “Preparation and Characterization of Sol-Gel Derived PLZT(8/65/35) Thin film on Pt/Ti/Si substrates”, Journal of Korean Physical society, Vol. 42, April 2003, p. S1097.

### FIELD OF THE INVENTION

This invention relates to the method of manufacture and use in multilayer ceramic capacitors of particles with a core-shell structure that have an electrically conducting core and at least one insulating dielectric shell layer. The conducting core particles can be powders of transition metals, a combination or alloy of more than one metal, or semiconductors. A conductive material with resistivity less than 10⁴ ohm-cm is preferred. The shell of insulating ceramic consists of one or more thinly coated layers of dielectric material. Glass frits, added as sintering aids, can also be a component of the shell or be an additional layer.

Multilayer ceramic capacitors made from said core-shell particles have the advantage of high effective dielectric constant, or improved dielectric strength and mechanical strength. This invention provides an effective and low-cost method to make multilayer ceramic capacitors with enhanced capacitance volumetric efficiency or higher stored energy density.

### BACKGROUND OF THE INVENTION

The multilayer ceramic capacitor (MLCC) has long been used as an important passive component, as well as an energy storage device, due to its low cost, small size, and high reliability. An MLCC consists of alternatively stacked ceramic dielectric layers (21) and metal electrode layers (22 and 23) as shown in FIG. 2. Ceramic dielectric with high permittivity, such as BaTiO₃, (Ba,Sr)TiO₃, (Ba,Ca)(Zr,Ti)O₃, Pb(Mg,Nb)O₃, and (Pb,La)(Zr,Ti)O₃ are commonly used to make MLCCs with high capacitance or high stored energy density. Dielectric ceramics with low dispassion factors, such as TiO₂, SrTiO₃, CaTiO₃, MgTiO₃, and BaZrO₃, or their composites are commonly used for high frequency applications or high voltage applications.

Depending on the application, the dielectric materials listed above are normally pre-formulated with functional ceramic dopants to modify the temperature coefficient of capacitance (TCC) defined by the Electronic Industries Association. For example, BaTiO₃ is normally formulated to meet EIA X7R specification (a capacitance change less than ±15% over the temperature range from −55° C. to +125° C.), and (Ba,Ca)(Zr,Ti)O₃ for EIA Y5V specification (a capacitance change within +22% to −82% over the temperature range from −30° C. to +85° C.). In addition, oxides of Ti, Mg, and Nd and oxides of Ca, Ti, and Si are used for EIA C0G specification (a capacitance change less than ±30 ppm over the temperature range from −55° C. to +125° C.). For certain applications, such as high voltage or energy storage applications, the capacitance change under bias voltage (also called voltage coefficient of capacitance) has to be taken into account in the circuit design.

The capacitance of a parallel plate capacitor is determined by the formula C=KεA/h (J. M. Herbert, “Ceramic Dielectrics and Capacitors”, Gordon and Breach Science Publishers, 1992. P 9), where the K is the dielectric constant, ε is a constant=8.854×10⁻¹², A is the active area between a pair of electrodes (22 and 23 in FIG. 2), and h is the thickness of the active layer sandwiched by the electrodes. Therefore, the capacitance value is proportional to the active area between a pair of electrodes and inversely proportional to the thickness of the active layer sandwiched by the electrodes. Reducing the active layer thickness is an effective way to improve the volumetric capacitance of a parallel plate capacitor. For a given size of the capacitor, the capacitance per unit volume will increase fourfold, if the active thickness is reduced by half. This is the reason that an MLCC has a much higher capacitance volumetric efficiency than ceramic single layer capacitors or disk capacitors. To follow the trend of miniaturization of microelectronic devices, MLCCs have needed to be smaller and smaller in size with higher and higher volumetric efficiency. This has been accomplished by reduction of the thickness of the dielectric layers.

Actually, great improvements in the reduction of the active layer thickness have been achieved recently. MLCC products with dielectric layers as thin as 2 μm have been successfully commercialized. Further reduction of the dielectric thickness is a challenge in the field of MLCC process engineering and ceramic powder technology. BaTiO₃ based X7R dielectric powder, the most widely used dielectric in MLCC industry, is a good example. MLCCs with 2 μm thick active layers are normally made with BaTiO₃ particles that are one order of magnitude or much smaller in size, i.e., 0.2 μm. The dispersion of submicron particles and the handling of 2 μm ceramic green sheets during the MLCC manufacturing processes require submicron level precision control. Upgrading equipment and automation to a submicron precision has become a major capital investment in the industry.

On the other hand, the permittivity of BaTiO₃ is a function of its grain size. With a grain size of 1 μm, the dielectric constant has a peak value of 5000. (B. W. Lee and K. H. Auh “Effect of grain size and mechanical processing on the dielectric properties of BaTiO₃”, J. Mater. Res, Vol 10, No. 6 June 1995, p. 1418). The reduction of the grain size will cause the dielectric constant to drop and make it gradually lose its attractive dielectric properties. When the grain size becomes 0.2 μm or less, ferroelectric BaTiO₃ loses its tetragonal crystal structure and becomes a paraelectric material with cubic structure, (Takeshi Nomura “Overview and Subject of Large Capacitance Multilayer Ceramic Capacitors” Ceramics, Vol. 36 (2001) pp 394.). In other words, for the application of ceramic capacitors, the particle size of BaTiO₃ is limited to about 0.2 μm in order to maintain -an adequate dielectric constant.

Since multilayer ceramic capacitors have a structure of alternatively stacked ceramic and metal electrode layers, the shrinkage mismatch between the ceramic layers and the metal electrode layers is the root cause of several structural defects, such as delaminations or micro-cracks. How to control the shrinkage mismatch has become an important process “know-how” in the industry. Adding ceramic fine particles to the metal paste that is printed to form the electrode layers is a useful method for controlling the shrinkage mismatch. However, with the reduction of active thickness, more and more layers, and more and more metal in total volume are integrated in a given size capacitor such that shrinkage mismatch control becomes more and more difficult.

Suzuki et al in U.S. Pat. No. 5,835,338 indicated that with the reduction of active thickness and the increase of the number of layer, MLCCs employing a high permittivity dielectric material have a drawback of low breakdown voltage due to mechanical cracks caused by the piezoelectric behavior of the high permittivity dielectric material and the distortion of the dielectric's crystal structure. Suzuki et al claimed a method to integrate 75 μm to 900 μm thick inter-layers in the capacitor's multilayer structure to mitigate the piezoelectric expansion. However, adding inter-layers conflicts with the goal of increasing the number of layers to increase the volumetric efficiency of a capacitor.

An energy storage device is another important application of MLCC's. Since the stored energy is proportional to the square of the capacitor's working voltage, as expressed in formula E=CV²/2, (The ARRL handbook for Radio Amateurs” 79^{th} edition, published by the national association for Amateur Radio, 2002. pp6.8), where the C is the capacitance and V is the working voltage of the capacitor, to store more energy in a given size capacitor, both high capacitance value and high working voltage are required.

Reducing the dielectric thickness, although it improves the capacitance value, does not improve the energy storage capability since the working voltage is going to be reduced proportionally to the active layer thickness. In addition, most ceramic capacitors made from high permittivity dielectrics have the tendency to lose capacitance under a DC bias, which suppresses the polarization of the dipole domains. As shown in FIG. 7, under a DC bias field of 6.7 V/μm, which is equivalent to a 100V DC bias applied across a 15 μm thick active layer, the capacitance of the MLCC made from BaTiO₃ core-shell particles drops to 25% of its original non-biased capacitance value.

Overall, the approach to further improve capacitance volumetric efficiency through reduction of the dielectric active thickness will be limited by the cost of the process and complexity of the technology. Besides, as a side effect, reduction of the dielectric active thickness will degrade the capacitor's working voltage.

Other ceramic dielectrics such as SrTiO₃, and CaTiO₃, which have quite low dielectric constant of 150-300, are suitable for high voltage applications due to their strong dielectric strength and less polarization loss under external bias voltage. Dielectrics based on PbTiO₃, especially when doped with La or Nb and known as PLZT or PNZT ceramics, respectively, have a unique phase transition from anti-ferroelectric to ferroelectric above room temperature. Galeb Maher in his U.S. Pat. No. 4,324,750 disclosed a method to make an MLCC with PLZT ceramics with high K, small change in the temperature coefficient of capacitance (TCC), and low voltage-coefficient of capacitance (VCC). Joseph Dougherty disclosed a PLZT dielectric capacitor for a cardiac defibrillator, a high discharge application, in his U.S. Pat. No. 5,545,184. A PLZT dielectric with the composition (Pb_{0.94}La_{0.6})(Zr_{0.95}Ti_{0.5})O₃ delivered an energy density as high as 6.05 J/cm³ under a 300 kV/cm field strength. As shown in FIG. 7, the VCC curve of PLZT is very different from that of other high dielectric constant material like BaTiO₃ Its capacitance value increases with the increase of the external DC bias, which makes PLZT an ideal dielectric for high energy storage or high energy discharge applications. However, the internal stress and dimensional changes associated with the phase transition during repeated charging and discharging usually results in mechanical failures, such as cracks and de-laminations, which directly weaken the dielectric withstand voltage and lowers the electrical strength of the device.

Other than reducing the active layer thickness, an alternative method to enhance the capacitance value of ceramic capacitors is to make use of a “grain boundary barrier layer” (GBBL) material as the dielectric. A GBBL material consists of coarse grains of semiconducting material with thin insulating barrier layers along the grain boundaries. In the past decade, numerous patents disclosed the use of semiconducting BaTiO₃ or SrTiO₃ in GBBL capacitors. The preparation of GBBL capacitors were reported by G. Goodman in his article “Capacitors Based on Ceramic Grain Boundary Barrier Layer—a Review” (Advanced in Ceramics, Vol. 1, 215-231, 1981) and by M. Fujimoto and W. D. Kingery in their paper “Microstructure of SrTiO₃ internal Boundary Layer Capacitors During and After Processing and Resultant Electrical Properties” (J. Am. Ceram. Soc., 68, [4] 169-173, 1985). Based on those reports, the process to make GBBL capacitors consists of two steps: 1) To sinter the oxide body in a reducing atmosphere to produce a semiconductor with large grains, and 2) To impregnate certain oxides into the sintered body to form a dielectric barrier layer in the grain boundary regions. BaTiO₃ and SrTiO₃ are commonly used as the semiconductor body and Bi₂O₃, CuO₂, CaO, and BaO are commonly used for impregnating the grain boundaries.

GBBL materials normally yield 10 to 20 times higher dielectric constant than the normal dielectric it is based on. Suk-Joong Kang et al in their U.S. Pat. No. 6,292,355 disclosed a SrTiO₃-based GBBL material formulation exhibiting an effective dielectric constant as high as 28000 with temperature coefficient less than ±10% over the temperature range from −60° C. to +60° C. A semiconducting BaTiO₃ based GBBL was reported with even higher effective dielectric constant. GBBL material with a dielectric constant as high as 60000 has actually been used for commercial single layer capacitor products (Microwave SLCs catalog, ULTRA MAXI series products, AVX Corporation, USA). However, there are several problems associated with the GBBL materials to hinder its application for multilayer capacitors, for which the dielectric layers and internal electrodes layer have to be co-sintered:
1) The wide distribution of semiconductor grain size and uneven thickness of the barrier layer result in a low resistivity and a low breakdown voltage of the capacitor.
2) The two-step sintering process, above 1300° C. in reduced atmosphere and re-oxidation at about 1000° C., limits the internal electrode selection for the MLCC co-firing process to pure Pd or other noble metals.
3) The process to impregnate oxides into the semiconductor ceramic body hinders the fabrication of multilayer electrodes which have to be buried in the ceramic body and co-fired.

Ian Burn et al studied the process conditions needed to make a strontium titanate based GBBL capacitor and filed U.S. Pat. No. 4,419,310 in 1983. In order to solve the process conflicts of co-firing with the necessary re-oxidation process, they proposed a method to replace a set of dummy electrodes which were pre-buried inside the multilayer ceramic body to make the GBBL material into multilayer capacitor. However, the process for making use of dummy electrodes did not become established MLCC technology because of the complexity.

### BRIEF SUMMARY OF THE INVENTION

This invention provides a method to manufacture multilayer ceramic capacitors by using core-shell structured dielectric particles instead of conventionally solid dielectric particles as the capacitor's active layers. The use of said core-shell particles which consist of a conductive core and at least one layer of insulating dielectric shell simplifies the MLCC manufacturing processes and effectively improves the multilayer ceramic capacitor properties. In particular, the use of core-shell particles with a thin shell of high permittivity dielectric material improves the capacitance volumetric efficiency, and the use of core-shell particles with a thick shell of dielectric will improve capacitor device's energy storage capacity as the results of improved electrical and mechanical strength.

### BRIEF DESCRIPTION OF THE DRAWINGS

FIG. 1 shows a core-shell particle cross section with a conductive metal core, a dielectric coated shell, and an outer layer of glass frits.

FIG. 2 shows a schematic view of the cross section of a multilayer ceramic capacitor.

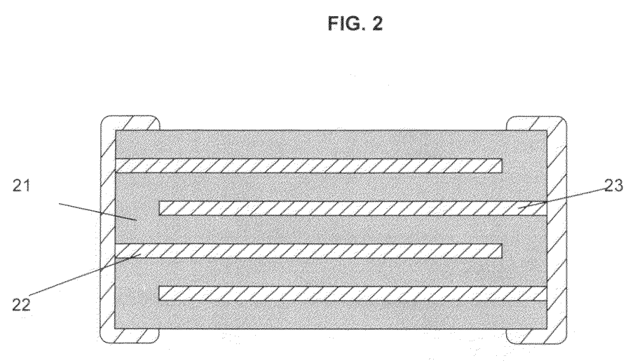

FIG. 3 shows the dimensional changes of PLZT ceramic, silver/palladium alloy particles coated with PLZT ceramic, and silver/palladium metal particles as a function of sintering temperature.

FIG. 4 shows a process flow chart to make core-shell particles into multilayer ceramic capacitors.

FIG. 5 shows the capacitance change of capacitors made from BaTiO₃, SrTiO₃ and PLZT core-shell particles as a function of temperature.

FIG. 6 shows the effective dielectric constant (K_{eff}) of the capacitors made from BaTiO₃, SrTiO₃ and PLZT core-shell particles as a function of shell thickness.

FIG. 7 shows the capacitance change of capacitors made from BaTiO₃, SrTiO₃ and PLZT core-shell particles as a function of bias voltage.

### DETAILED DESCRIPTION OF THE INVENTION

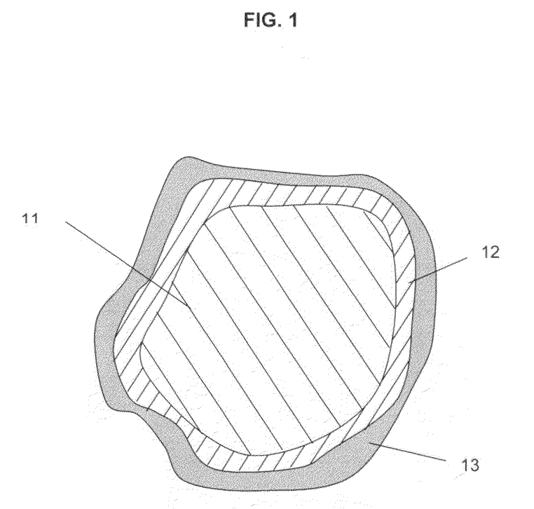

This invention provides a method to make core-shell structured dielectric particles, as shown in FIG. 1, and a method to make the core-shell particles into a multilayer ceramic capacitor. The core-shell structured particles consist of a conductive core portion (11) and insulating dielectric shell or shells (12). The conductive core particles normally include conductive materials such as transition or other metals, alloys of metals, or semiconductors. The metals can include, but are not limited to base-metals such nickel, cobalt, iron, tungsten, tantalum, molybdenum, copper, aluminum or titanium, and the noble metals silver, gold, palladium, platinum, or the combination of any of these metals and their alloys.

The conductive materials can have particle sizes in the range of about 0.1 μm to about 50 μm, and preferably in the range of about 0.5 μm to about 10 μm in the shape of spheres, plates, or flakes. The conductive core particles could also be a semiconductor, such as semi-conductive metal oxide, metal nitrides, or graphite and carbon particles. Materials having a resistivity less than 10⁴ ohm-cm and having a melting point higher than 800° C. are preferred.

Dielectric materials with a thickness more than 10 nm are applied on the surface of the conductive core particles to form insulating shells through chemical wet coating methods. A shell thickness less than 10 nm may have a low resistivity or cause electrical shorting when the core-shell particles are made into the capacitor devices. In order to make high quality shells with less defects and uniform thickness, chemical coating through reaction such as sol-gel, hydrothermal, co-precipitation methods, or chemical vapor deposition are preferred. To make a thicker dielectric shell, pre-formulated dielectric powder in small size, usually 10% or less than the size of the conductive core particles, could be coated through a wet slurry coating method. For example, dispersing both conductive core particles and a nanosize dielectric powder into a suspension slurry the smaller size of dielectric powder would be coated on the surface of the core particles after the slurry being dried. The coated shell thickness is determined by the volume ratio of the conductive particle to the dielectric powder, the solids loading of the suspension slurry, and the slurry viscosity.

Glass compositions such as those based on Bi₂O₃, CuO₂, CaO, B₂O₃, Li₂O or the combination of more than one of these oxides could also be coated as an extra layer (13), as illustrated in FIG. 1, to the outside of the conductive core or be used as partial precursor of the dielectric formulation to be used in the shell layer for the purpose of reducing the firing temperature and to improve the fired density of the MLCC.

An objective of the invention is to make use of core-shell structured particles instead of conventional solid dielectric particles in order to enhance the capacitance volumetric efficiency. Since the core particles are conductive, only the shell portion of each particle works as the active dielectric and contributes to the dielectric properties to the capacitor. Therefore the actual thickness of the dielectric portion of an MLCC active layer made from the core-shell particles will actually be reduced in proportion to the ratio of the core diameter to the shell thickness. For example, in the case of a 15 μm thick active layer made from core-shell particles with 1.5 μm diameter nickel particles coated with 10 nm of BaTiO₃ (Example 1), there are 10 particles aligned in the direction across the active layer and the total dielectric shell thickness of the 10 particles is 200 nm, only 13% of the active layer thickness. The capacitance value will theoretically become 7 times higher since it is inversely proportional to the active layer thickness. For the purpose of enhancing the capacitance volumetric efficiency, a combination of high permittivity, thin shell thickness, and larger core particles will result in 10 times or more effective dielectric constant and volumetric efficiency. Capacitance volumetric efficiency near 1000 μF/cm³ was achieved in an MLCC designed with a 15 μm thick active layer made from a 5 μm diameter and 0.5 μm thick silver flakes coated with a 10 nm thick BaTiO₃ shell (Example 2A). A similar volumetric efficiency of capacitance can only be achieved by use of 5 μm active layers if a conventional X7R BaTiO₃ formulation with dielectric constant of 3000 is used.

Another objective of the invention is to make use of the core-shell structured particles instead of conventional solid dielectric particles to improve the MLCC's energy storage density. In such a case, both capacitance and electrical strength of the device need to be improved, and the later contributes more to the energy density since it is proportional to the square of the applied voltage, according to formula E=CV²/2. Ceramic materials with high dielectric breakdown strength and a dielectric constant that changes little with an applied bias, such as SrTiO₃, TiO₂, CaTiO₃, MgTiO₃, BaZrO₃, or a combination of two or more of these are preferred shell materials for energy storage applications. To achieve high breakdown strength, conductive particle sizes in the range from 0.1 μm to 100 μm and shell thickness between 50 nm to 500 nm are preferred. An energy density of 3.2 J/cm³ was achieved in for a 250V rated MLCC device with a 15 μm thick active layer made from a core-shell particles with 1.5 μm diameter conductive particles coated with a 50 nm thick SrTiO₃ shell (Example 4E in Table 2).

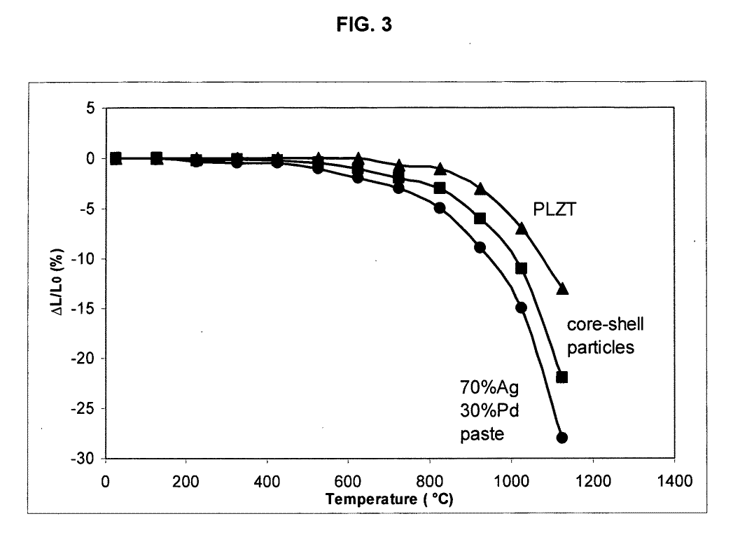

Furthermore, an additional objective of the invention is to use core-shell particles to improve the mechanical properties of a co-fired ceramic capacitor body with many ceramic active layers and metal electrodes. FIG. 3 shows the physical dimensional change of a PLZT ceramic consisting of 70% silver/30% palladium alloy core particles coated with PLZT dielectric versus a dried 70% silver/30% palladium alloy particle paste, as a function of sintering temperature. The PLZT coated metal particles have a shrinkage curve between that of solid PLZT ceramic and the pure metal electrode and limits the maximum shrinkage mismatch from 15% (between PLZT ceramic and pure metal electrode) to 5% (between PLZT coated core-shell particle and the metal electrode).

Example 5E shows a capacitor made using 50 nm PLZT coated particles. The co-fired multilayer ceramic capacitor body consists of 20 active layers each 15 μm thick. A 250V external bias voltage applied to the active layers which have 10 core-shell particles between each pair of electrodes creates a stored energy of 14.6 Joule/cm³.

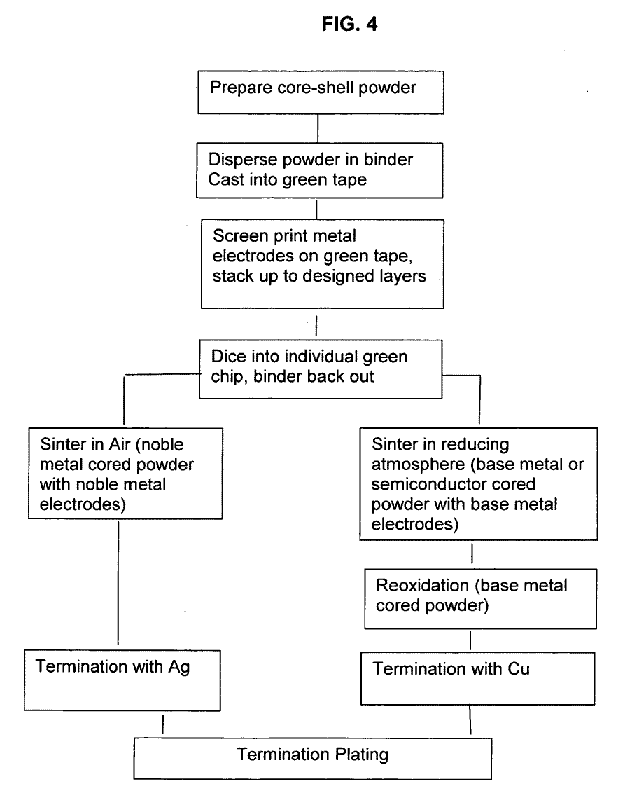

The processes to make the core-shell particles and to make the core-shell particles into multilayer ceramic capacitors are illustrated in FIG. 4, with the starting step of preparing the conductive core—insulating shell particles. Dielectric shell applied on the surface of conductive core through synthesizing process such as sol-gel, co-precipitation, hydrothermal methods normally has a dense and even coating. However, to apply a pre-formulated fine dielectric powder though a slurry coating method is an effective process to coat thicker shells for massive production.

When a sol-gel method is adopted, the first step is to prepare the dielectric precursors containing organic metal alkoxides in the desired concentration and required formulation. In order to obtain a sol solution to produce a dielectric material of the required crystal structure, precise control of the mole ratio of organic metal alkoxides and extensive refluxing (a few hours to a few days) of the organic metal alkoxide precursors are necessary. Subsequently, the pre-dispersed conductive core particles will be added to the sol solution to be followed by the addition of water to hydrolyze the sol solution into a viscous gel that deposits evenly on the surface of the conducting core particles. The thickness of the deposited shell is determined by the gel concentration and its viscosity. A high density, crack free shell layer results when the gel is dried slowly and then subjected to a high-temperature annealing process. In order to reach a certain shell thickness, repeating the deposition, drying, and annealing may be necessary. Different dielectric composition may need to be annealed at different temperatures to obtain the desired dielectric properties. Multiple coatings of low concentration sol solution produce a more uniform shell thickness with fewer defects. Example 1 describes in detail a BaTiO₃ sol-gel coating process.

Co-precipitation is an economical alternative to coat dielectric materials onto conductive core particles. In the case to precipitate BaTiO₃ as the shell dielectric, the conductive core particles need to be dispersed in an oxalate solution containing BaCl₂ and TiCl₄. Fine barium titanate particles will then be produced on the surface of the conductive particles during thermal decomposition of the barium titanyl oxalate. The coated particles will become core-shell structured after being washed and spray dried.

Depending on the metal powder chosen for the internal electrodes, which determines the maximum temperature that the multilayer capacitor can be fired, sintering aids consisting of low-melting point oxides such as bismuth oxide, lithium oxide, calcium oxide or their mixtures can also be coated onto the shell.

The next step is to make the above core-shell particles into multilayer ceramic capacitors in the processes as shown in FIG. 4. The core-shell particles first need to be dispersed in a binder solution to obtain a viscous slurry with the proper viscosity, so that the slurry can be cast on to a moving carrier such as a steel belt or polymer film. A thin ceramic sheet is produced with a thickness ranging from a few microns to a few millimeters, depending on the application of the MLCC. A dispersant or surfactant, plasticizer, and a small quantity of other additives are added to the slurry in order to obtain green sheet made by the tape casting process that has a smooth surface and is easy to handle. Glass frits can also be added to the slurry mixture to reduce the firing temperature and improve the fired density of the ceramic layers.

A metal electrode is carefully selected to match the dielectric layer based on the firing temperature, firing atmosphere, and shrinkage curves of both the ceramic layers and the metal electrodes. For example, if the active layers are made from core-shell particle that have to be sintered in air, base metal electrode such as Ni or Cu should not be selected as the internal electrode. If the active layer has to be sintered as high as 1300° C. to obtain a dense dielectric shell, using of a low melting point metal such as pure silver should be avoided.

The metal powder selected for the internal electrodes is dispersed in an organic vehicle to form a metal paste to be applied to the surface of the green sheet by a screen printing method, or the like, in a pre-determined pattern to form the internal electrodes. Subsequently, a desired number of the green sheets having the metal paste applied thereon are superimposed upon each other in such a manner that the green sheets and the metal paste overlap each other, in such a way that a multilayer built structure is obtained. Thereafter, the multilayer structure is pressed with heating, and then diced into multilayer green chips having predetermined dimensions. The green chips first go through a binder burn out process at a temperature high enough to thermally decompose the polymeric binder and then are co-fired at a controlled temperature and atmosphere. In the case of base-metals, used for either the core-shell particles or electrode paste, the atmosphere during binder burn out and firing must not oxidize the core-shell particles or the electrodes. A controlled temperature means a temperature high enough to form a liquid phase at the junction of coated core-shell particles, but not too high to melt the conductive core material or printed metal electrodes. The coated dielectric shell will form thin barrier layers along the conductive particle surface through the co-firing. The thickness of the barrier layers is determined by the coated shell thickness, co-firing temperature, co-firing soak time, sintering aids added, and the conductive core particle size, which is normally in the range from 10 nanometers to 200 nanometers. A controlled atmosphere means limited oxygen partial pressure inside the furnace. For example, a multilayer structure using nickel core particle with sol-gel coated BaTiO₃ shell as the active layer and nickel paste as the internal electrodes, needs to be sintered at 1300° C. under a N₂/H₂ atmosphere to form a dense monolithic capacitor without oxidation of the nickel core particles or nickel electrodes. Also the fired multilayer capacitor chips need to be annealed under a partial oxygen pressure at about 1100° C. to re-oxidize the BaTiO₃ shell material into an insulating dielectric. If the multilayer structure consists of a noble metal core particle in the active layer and a noble internal electrodes, it needs to be sintered in air at a temperature of 800° C. to 1300° C. depending on how much and what kinds of sintering aid or glass frits are added.

After co-firing, monolithic MLCC chips are formed. Following necessary post processing, including corner rounding, adding end terminations, and electroplating the MLCC chips are ready for electrical testing and sorting.

### EXAMPLES

### Example 1

### Nickel Powder With Sol-Gel Coated BaTiO₃

A sol solution of 0.2 mol/L barium titanate was prepared by mixing 0.2 mol/L barium isopropoxide Ba(OC₃H₇)₂ solution (Chemat, U.S) with 0.2 mol/L titanium amyloxide Ti(OC₅H₁₁)₄ solution (Aldrich, U.S) and refluxing at 80° C. overnight as a stock solution. Then 400 g of pre-dispersed nickel powder (average particle size D50=1.5 μm, surface area=1.0 m²/g) was added to 1 liter of the above pre-prepared barium titanate sol solution, continuously stir and refluxing for 4 more hours.

Distilled water was slowly added to the powder coating vessel while stirring to hydrolyze the sol solution into a BaTiO₃ gel solution to be coated on the nickel powder. One liter of 0.2 mol/L BaTiO₃ gel solution coats 400 g of metal powder to a thickness of 20 nanometers. Shell thicknesses from 10 nanometers to 50 nanometers were obtained by adjusting the concentration of the sol solution in the range from 0.1 mol/L to 0.5 mol/L. The coated core-shell particles were then dried in a vacuum oven and annealed in air up to 550° C. to become a loose agglomerated powder.

### Example 2

### Silver Flake With Sol-Gel Coated BaTiO₃

The same barium titanate sol stock solution made in Example 1 was used to coat pure silver flakes in the same way as illustrated as Example 1. BaTiO₃ shells in the thickness range from 10 nm to 50 nm were obtained as five different core-shell samples as shown in Table 1.

### Example 3

### Sol-Gel Derived Ba_{0.6}Sr_{0.4}TiO₃ Shells on Ni Core Particles

0.6 liters of 0.2 mol/L barium isopropoxide Ba(OC₃H₇)₂ solution, 0.4 liters of 0.2 mol/L strontium isoproppoxide Sr(OCH(CH₃)₂)₂ solution, and 1.0 liter 0.2 mol/L titanium amyloxide Ti(OC₅H₁₁)₄ solution were added in a glass vessel together and refluxed at 80° C. overnight to obtain 2 liters of 0.2 mol/L Ba_{0.6}Sr_{0.4}TiO₃ sol solution. 400 g nickel powder (average particle size D50=1.5 μm, surface area=1.0 m²/g) was then dispersed into a glass vessel loaded with 1.06 liters of the above prepared 0.2 mol/L Ba_{0.6}Sr_{0.4}TiO₃ stock solution. Distilled water was added slowly to the nickel powder coating vessel while stirring to hydrolyze the sol solution into a Ba_{0.6}Sr_{0.4}TiO₃ gel solution for coating on the well dispersed nickel powder, producing a shell 20 nanometers in thickness after being dried and annealed.

### Example 4

### SrTiO₃ Shell on Ni Core Particles

A strontium titanate shell on Ni particles was produced by omitting the barium precursor in Example 3.

### Example 5

### Sol Gel PLZT (8/80/20) Shell on 30% Pd/70% Ag Metal Powder

The sol precursors were prepared from lead acetate trihydrate (Aldrich), titanium isopropoxide (Aldrich), zirconium n-propoxide (Aldrich), and lanthanum isopropoxide (Chemat). 1.0 mole of lead acetate trihydrate was first dissolved in methoxy ethanol and heated to 80° C. in a flask for 3 hours. 0.08 mole of lanthanum isopropoxide was then added to the flask and re-fluxed for additional 3 hours. A 0.8 mol zirconium n-propoxide with a 0.2 mole of titanium isopropoxide were dissolved in a separate flask with methoxy ethanol to reflux at 80° C. for 3 hours to form Zr/Ti precursor. Then, the Pb/La precursor and Zr/Ti precursor were mixed together and refluxed for additional 3 hours at 80° C. as a stock sol solution. The mole ratio of the solution was 8La/80Zr/20Ti with 8% excess of lead. 400 g of 70w % Ag/30 w % Pd alloy powder (average particle size D50=1.0 μm, surface area=0.7 m2/g) was then added to 0.72 liter of the above prepared 0.2 mol/L sol solution, continuously stirring and refluxing for 4 more hours.

Distilled water was slowly added to the powder coating vessel while stirring to hydrolyze the sol solution into PLZT gel solution to be coated on the well dispersed metal powder. The coated metal powder was annealed at 800° C. after being dried in a vacuum oven. Shell thicknesses in the range of 20 nanometers to 50 nanometers were obtained by repeating the coating process 2 to 5 times.

### Example 6

### Coating a Barium Titanate Shell by the Hydrothermal Method on 70% Silver/30% Palladium Alloy Metal Particles

400 g of 70% silver/30% Pd metal particles were dispersed in a glass vessel loaded with 0.2 mol/L Ba(OH)₂ solution. Then 0.2 mol/L TiCl₄ water solution was added to the vessel to generate 48 g of BaTiO₃ which covered the 400 g of metal powder with 20 nano-meters of shell. Residual Ba ions were washed away and the coated powder was dried in a freeze dryer to prevent the agglomeration of the particles.

### Example 7

### Sol-Gel Barium Titanate Shell on Semiconducting Barium Titanate Core Particles

A cerium-doped semiconducting oxide powder with the composition Ba_{0.7}Ce_{0.}TiO₃ (average particle size D50=3 μm, surface area=0.3 m²/g) was used as the core particles. The powder had a bulk resistivity of 22 ohm-cm as measured on a disk-shaped sample at room temperature. These semiconducting core particles were coated with sol-gel barium titanate solution that was made as in Example 1 with different shell thicknesses from 10 nm to 50 nm.

### Example 8

### Nano-Size Barium Titanate Powder on Ni Core Particles

320 g barium titanate powder in the shape of wet cake (containing 20% water) with average particle size of 100 nm made by the hydrothermal synthesis method together with 400 g Ni particles ( same as that used in Example 1) are dispersed into 160 g of UCAR 820 latex (Dow Chemical, USA) suspension emulsion to become a viscous slurry. Additional water was also added to the slurry to adjust the viscosity. After 5 passes though a sand mill machine to enhance its dispersion the slurry was spray dried into loss agglomerated core-shell particles with 200 nm shell thickness. By changing the volume ratio of conductive core to barium titanate nano-powder and the solids loading of the slurry, core shell particles with shell thickness from 200 nm to 500 nm were made and used for sample 8A to 8d in Table 2 for high voltage MLCC application.

A pre-dried barium titanate nano-size powder was also used to coat the conductive core particles instead of the barium titanate nano-size powder in the wet cake shape. 10 or more passes through the sand mill machine were necessary for the dried barium titanate powder to be dispersed in the slurry evenly. Instead of spray drying it into a powder shape, the slurry could be directly cast on to a moving carrier such as a steel belt or polymer film into a green sheet.

The following examples describe the process to make the core-shell particles into a multilayer capacitor.

### Example 1A

400 g of core-shell particles made as in Example 1 (nickel core particles with a 10 nanometer thick BaTiO₃ shell) were added to a ball mill charged with 24 g of polyvinyl butyral resin flake (Sekisui, Japan) pre-dissolved in 198 g toluene and 98 g ethanol mixed solvent to mill for 2 hours. Then, 12 g of S-160 plasticizer (Ferro, US) together with 4 g of Glygoyle HE 460 lubricant (Exxon Mobil, US) were add to the ball mill and milled another 3 hours to make a castable slurry. The slurry viscosity and solids concentration were properly adjusted to cast on a moving steel belt to produce green sheet with a thickness of 18 μm after drying of the solvents.

A nickel internal electrode paste was screen-printed onto the green sheets and subsequently overlapped up to 20 layers. After laminating with top and bottom covers made from the same green sheet, multilayer green chips in a 1206 case size (0.12 inch×0.06 inch) pattern were diced and subjected to binder burn-out at 350° C. for 3 hours. Then the multilayer chips were co-fired at 1300° C. in a N₂/H₂ forming gas atmosphere for 3 hours. During the cool down stage, the fired chips were annealed at 980° C. for 2 hours under an oxygen partial pressure sufficient to re-oxidize the BaTiO₃ shell part of the active layers. Post processing, including corner rounding, adding end terminations, and electroplating were conducted to make the MLCC chips suitable for electrical measurement. Capacitance value and dissipation factor (DF) were measured using a HP 4278A capacitance meter. Dielectric and electrical properties are summarized in Table 2. Based on the minimum breakdown voltage of 15V, the MLCC parts were suitable for a 10 volt rated application with capacitance value of 1.0 μF. This is equivalent to an effective dielectric constant (K_{eff}) as high as 22000 with a temperature coefficient of capacitance of ±12% from −55° C. to 125° C.

### Examples 2A to 2E

### MLCC Chips Made From the Core-Shell Particles of Example 2 With Different Shell Thicknesses

To match the shrinkage of the core particle of a pure silver flake, a 100% Ag electrode paste was selected as the internal electrode material. In order to reduce the firing temperature below 960° C. (the melting temperature of pure silver), nano-sized powders of Bi₂O₃ and B₂O₃ mixed in 1 to 1 ratio were added to the casting slurry before casting it into an 18 μm thick green sheet. Although it was fired at as low as 930° C., The capacitor device shown as Example 2A had an effective dielectric constant K_{eff} as high as 25000, which is calculated based on the equation of C=KεA/h with an h value of 15 μm. Volumetric efficiency as high as 983 μF/cm³ was achieved in a 1206 case size MLCC made using 10 nm thick BaTiO₃ coated nickel core particles with a design of forty 15 μm thick fired active layers (Example 2A) This is equivalent to a 1206 case size MLCC made with 5 μm thick active layers and barium titanate dielectric having a dielectric constant of 3000.

### Examples 4A to 4E

### MLCC Chips Made Using the Nickel Core and SrTiO₃ Shell Particles of Example 4 With Different Shell Thicknesses

As shown in Example 4E in Table 2, MLCCs made from core-shell particles with 50 nm thick SrTiO₃ shell could withstand up to 250V DC voltage. A 20 layer 1206 case size MLCC is able to store energy up to 3.17 Joule/cm³.

### Examples 5A to 5E

### MLCC Chips Made With 70% Silver/30% Palladium Alloy Particles Coated With PLZT From Example 5 With Different Shell Thicknesses

Example 5E in Table 2 is a 1206 case size capacitor with twenty 15 μm thick active layers made from 50 nm thick PLZT coated on 70% silver/30% palladium alloy particles. It has an energy density as high as 14.6 Joule/cm³.

### Examples 7A to 7E

### MLCC Chips Made Using Ba_{0.7}Ce_{0.}TiO₃ Semiconductor Particles Coated With BaTiO₃ With Different Shell Thicknesses, as Described in Example 7

Compared to the MLCCs of Examples 2A to 2E, capacitors made from semiconductor cored particles have relatively higher insulation resistance and lower effective dielectric constant.

### Examples 8A to 8D

### MLCC Chips Made Using Nano-Size Barium Titanate Powder Coated Ni Core Particles With Different Shell Thicknesses From 200 nm to 500 nm, as Described in Example 8

As shown in Table2, MLCC samples with thicker shells (8A to 8D) have lower effective dielectric constant (K_{eff}) and higher break down voltages than the MLCC samples made from thinner shell thicknesses (2A to 2E).

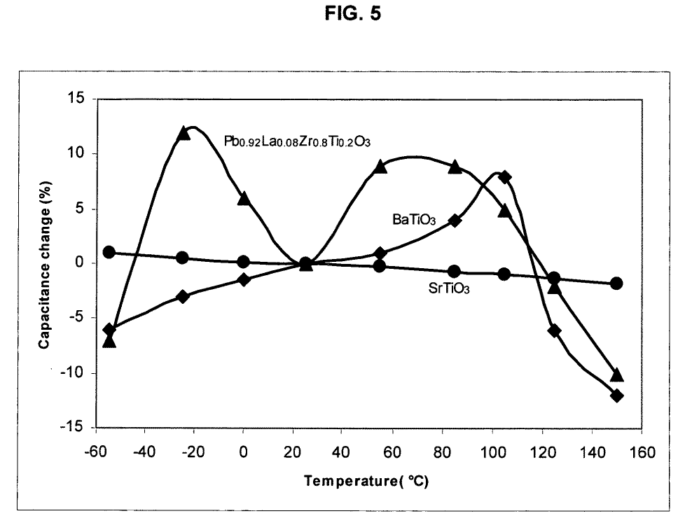

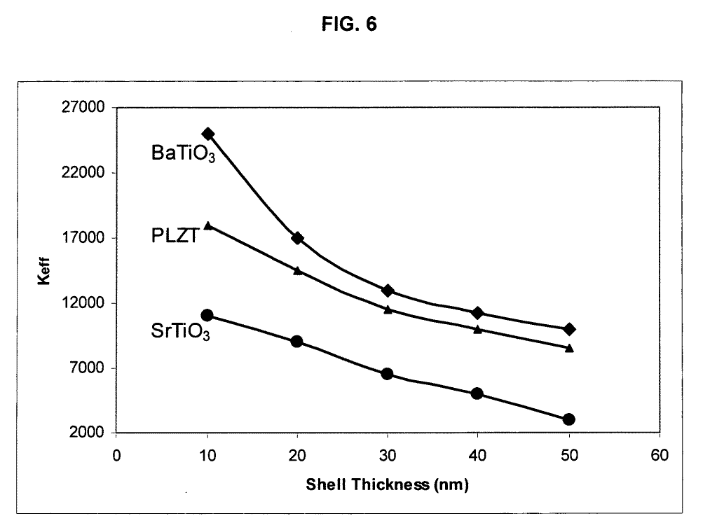

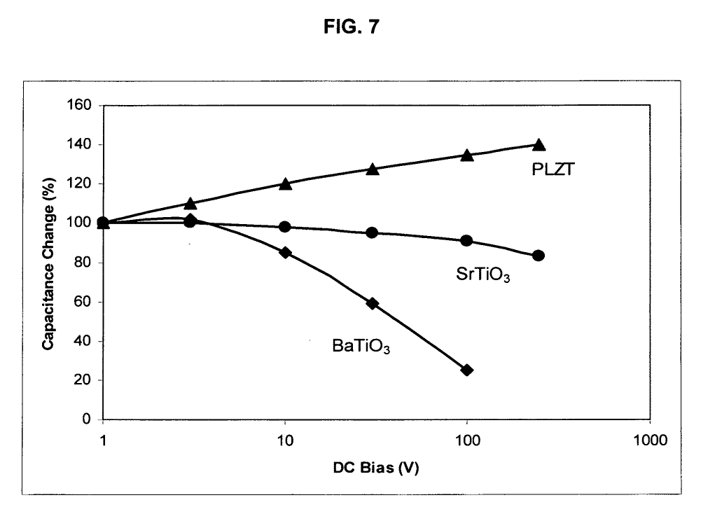

The temperature coefficient of capacitance (TCC) of three multilayer ceramic capacitors made from BaTiO₃, SrTiO₃, and PLZT core-shell particles described in Examples 2, 4, and 5, respectively are plotted in FIG. 5. All three meet the EIA X7R defined requirement: within ±15% over the temperature range from −55° C. to +125° C. FIG. 6 shows the effective dielectric constant of three MLCCs made from BaTiO₃, SrTiO₃, and PLZT core-shell particles described in Examples 2, 4, and 5 as a function of the shell thickness. FIG. 7 shows the voltage coefficient of capacitance (VCC) of three multilayer ceramic capacitors made from the BaTiO₃, SrTiO₃, and PLZT core-shell particles described in Example 2, 4, and 5 as a function of DC bias voltage.

TABLE 1

| | Core | | | | | |
|---|---|---|---|---|---|---|
| Example | coating | | | surface | Shell | |
| No. | method | materials | particle size | area | materials | thickness |
| 1 | sol-gel | Ni powder | 1.5 μm | 1.0 m²/g | BaTiO₃ | 10 to 50 nm |
| 2 | sol-gel | pure Ag flake | D = 5 μm, t = 0.5 μm | 0.5 m²/g | BaTiO₃ | 10 to 50 nm |
| 3 | sol-gel | Ni powder | 1.5 μm | 1.0 m²/g | BaSrTiO₃ | 10 to 50 nm |
| 4 | sol-gel | Ni powder | 1.5 μm | 1.0 m²/g | SrTiO₃ | 20 to 50 nm |
| 5 | sol-gel | Ag/Pd alloy | 1.0 μm | 0.7 m²/g | PLZT | 20 to 50 nm |
| 6 | hydrothermal | Ag/Pd alloy | 1.0 μm | 0.7 m²/g | BaTiO₃ | 30 to 100 nm |
| 7 | sol-gel | BaCeTiO₃ | 3.0 μm | 0.3 m²/g | BaTiO₃ | 10 to 50 nm |
| 8 | slurry | Ni powder | 1.5 μm | 1.0 m²/g | BaTiO₃ | 200 to 500 nm |

TABLE 2

| Sam- | Core | | Shell | | Actives | | | | | | | | | C/V | E/V |
|---|---|---|---|---|---|---|---|---|---|---|---|---|---|---|---|
| ple | | core | | thickness | active | thickness | Internal | Cap | | DF | TCC | IR | BWV | (uF/ | (Jol/ |
| No. | matrials | size (um) | dielectric | (nm) | layers | (um) | Electrode | (uF) | k_{eff} | (%) | (%) | (Ω-cm) | (V) | cm3) | cm3) |
| 1A | Ni powder | D = 1.5 | BaTiO₃ | 10 | 20 | 15 | 100% Ni | 1.17 | 22000 | 3.5 | ±12% | 6.0E8 | 15 | 865.72 | 0.10 |
| 2A | Ag flake | t = 0.5, | BaTiO₃ | 10 | 40 | 15 | 100% Ag | 2.66 | 25000 | 3.5 | ±12% | 6.0E8 | 15 | 983.78 | 0.11 |
| | | D = 5 | | | | | | | | | | | | | |
| 2B | Ag flake | t = 0.5, | BaTiO₃ | 20 | 40 | 15 | 100% Ag | 1.81 | 17000 | 2.5 | ±12% | 1.2E9 | 25 | 668.97 | 0.20 |
| | | D = 5 | | | | | | | | | | | | | |
| 2C | Ag flake | t = 0.5, | BaTiO₃ | 30 | 40 | 15 | 100% Ag | 1.38 | 13000 | 1.9 | ±12% | 1.8E9 | 50 | 511.56 | 0.54 |
| | | D = 5 | | | | | | | | | | | | | |
| 2D | Ag flake | t = 0.5, | BaTiO₃ | 40 | 40 | 15 | 100% Ag | 1.19 | 11200 | 1.5 | ±12% | 2.5E9 | 85 | 440.73 | 0.88 |
| | | D = 5 | | | | | | | | | | | | | |
| 2E | Ag flake | t = 0.5, | BaTiO₃ | 50 | 40 | 15 | 100% Ag | 1.06 | 10000 | 1.5 | ±12% | 2.8E9 | 100 | 393.51 | 0.49 |
| | | D = 5 | | | | | | | | | | | | | |
| 4A | Ni powder | D50 = 1.5 | SrTiO₃ | 10 | 20 | 15 | 100% Ni | 0.58 | 11000 | 0.15 | ±2% | 2.0E9 | 50 | 432.86 | 0.54 |
| 4B | Ni powder | D50 = 1.5 | SrTiO₃ | 20 | 20 | 15 | 100% Ni | 0.48 | 9000 | 0.12 | ±2% | 4.3E9 | 75 | 354.16 | 1.00 |
| 4C | Ni powder | D50 = 1.5 | SrTiO₃ | 30 | 20 | 15 | 100% Ni | 0.35 | 6500 | 0.09 | ±2% | 8.0E9 | 100 | 255.78 | 1.21 |
| 4D | Ni powder | D50 = 1.5 | SrTiO₃ | 40 | 20 | 15 | 100% Ni | 0.27 | 5000 | 0.08 | ±2% | 1.2E10 | 180 | 196.76 | 2.90 |
| 4E | Ni powder | D50 = 1.5 | SrTiO₃ | 50 | 20 | 15 | 100% Ni | 0.16 | 3000 | 0.05 | ±2% | 2.5E10 | 250 | 118.05 | 3.17 |
| 5A | Ag—Pd | D50 = 1.5 | PLZT | 10 | 20 | 15 | Ag—Pd | 0.96 | 18000 | 1.8 | ±12% | 3.0E8 | 30 | 708.32 | 0.35 |
| 5B | Ag—Pd | D50 = 1.5 | PLZT | 20 | 20 | 15 | Ag—Pd | 0.77 | 14500 | 1.7 | ±12% | 6.0E9 | 60 | 570.59 | 1.23 |
| 5C | Ag—Pd | D50 = 1.5 | PLZT | 30 | 20 | 15 | Ag—Pd | 0.61 | 11500 | 1.5 | ±12% | 9.0E8 | 125 | 452.54 | 4.53 |
| 5D | Ag—Pd | D50 = 1.5 | PLZT | 40 | 20 | 15 | Ag—Pd | 0.53 | 10000 | 1.4 | ±12% | 1.2E9 | 200 | 393.51 | 10.62 |
| 5E | Ag—Pd | D50 = 1.5 | PLZT | 50 | 20 | 15 | Ag—Pd | 0.45 | 8500 | 1.2 | ±12% | 1.5E9 | 250 | 334.48 | 14.63 |
| 7A | BaCeTiO₃ | D50 = 3 | BaTiO₃ | 10 | 20 | 30 | 100% Ag | 0.21 | 8000 | 3.1 | ±15% | 2.0E9 | 25 | 78.70 | 0.02 |
| 7B | BaCeTiO₃ | D50 = 3 | BaTiO₃ | 20 | 20 | 30 | 100% Ag | 0.19 | 7300 | 2.9 | ±15% | 2.5E9 | 45 | 71.82 | 0.07 |
| 7C | BaCeTiO₃ | D50 = 3 | BaTiO₃ | 30 | 20 | 30 | 100% Ag | 0.18 | 6800 | 2.6 | ±15% | 2.8E9 | 65 | 66.90 | 0.09 |
| 7D | BaCeTiO₃ | D50 = 3 | BaTiO₃ | 40 | 20 | 30 | 100% Ag | 0.17 | 6300 | 2.4 | ±15% | 3.1E9 | 85 | 61.98 | 0.10 |
| 7E | BaCeTiO₃ | D50 = 3 | BaTiO₃ | 50 | 20 | 30 | 100% Ag | 0.16 | 6000 | 2.1 | ±15% | 4.5E9 | 100 | 59.03 | 0.10 |
| 8A | Ni powder | D50 = 1.5 | BaTiO₃ | 200 | 20 | 30 | 100% Ni | 0.37 | 14000 | 2.2 | ±15% | 9.0E9 | 180 | 137.73 | 2.01 |
| 8B | Ni powder | D50 = 1.5 | BaTiO₃ | 400 | 20 | 30 | 100% Ni | 0.24 | 9200 | 2.1 | ±15% | 2.1E10 | 250 | 90.51 | 2.26 |
| 8C | Ni powder | D50 = 1.5 | BaTiO₃ | 600 | 20 | 30 | 100% Ni | 0.18 | 6900 | 2.1 | ±15% | 4.5E10 | 350 | 67.88 | 2.91 |
| 8D | Ni powder | D50 = 1.5 | BaTiO₃ | 800 | 20 | 30 | 100% Ni | 0.15 | 5500 | 1.8 | ±15% | 8.5E10 | 500 | 54.11 | 3.38 |

What is claimed is:

1. Particles with a core-shell structure having a conducting core of a metal or semiconductor and an insulating shell consisting of at least one dielectric layer, the dielectric shell being applied to the conducting particles by a chemical coating technique.

2. The conducting core particles of claim 1 selected from metals, metal compounds, their alloys or semiconducting materials with resistivity less than 10⁴ ohm-cm.

3. The conducting core particles of claim 2 with a particle size of 0.1 to 50 μm.

4. The conducting core particles of claim 2 with a melting point higher than 800° C.

5. The conductive core particles of claim 2 selected from Ag, Pd, Pt, Au, Rh, Ru and alloys thereof and Cu, Ni, Co, Fe, W, Ta, Nb, Mo, Ti, V, Cr, Mn and alloys thereof.

6. The conductive core particles of claim 2 selected from semiconductors including doped TiO₂ and other doped transition metal oxides, donor-doped BaTiO₃ and SrTiO₃, and semiconducting perovskites such as lanthanum nickelate.

7. The conductive core particles of claim 2 selected from metal nitrides such as silicon nitride or carbides such tungsten carbide.

8. The conductive core particles of claim 2 selected from carbon and graphite.

9. The conductive core particles of claim 2 selected from conductive cuprate oxides such as yttrium barium copper oxide (YBCO) and bismuth strontium calcium copper oxide (BSCCO).

10. Ceramic shell materials of claim 1 consisting of at least one uniform coating of dielectric material applied to the conductive cores by sol-gel technology, solution coating, chemical precipitation, hydrothermal processing, or chemical vapor deposition in the thickness range of 10-500 nm.

11. The insulting ceramic shells of claim 1 consisting of at least one uniform coating of dielectric powder applied to the conductive cores by slurry coating technology in the thickness range of 0.1-10 μm.

12. The slurry of claim 11 consisting of at least one kind of conductive core particles and at least one kind of dielectric powder in the volume ratio from 1 (1 part of conductive core particle to 1 part of dielectric powder) to 10 (1 part of conductive core particle to 10 part of dielectric powder).

13. The insulating ceramic shells of claim 1 with dielectric compositions meeting the EIA TCC specifications of X7R, or Y5V, or C0G.

14. The insulating ceramic shells of claim 1 with dielectric compositions made from titanates such as TiO₂, BaTiO₃, SrTiO₃, CaTiO₃, PbTiO₃ and MgTiO₃, zirconates such as CaZrO₃, BaZrO₃, SrZrO₃ and mixtures or solid solutions thereof.

15. The insulating ceramic shells of claim 1 with composition based on lead zirconate titanate, lead lanthanum zirconate titanate, and lead magnesium niobate.

16. The insulating shells of claim 1 including glass compositions or low melting fluxes such as boron oxide, bismuth oxide, lithium oxide, aluminum oxide, silicon oxide, calcium oxide and combinations thereof.

17. A multilayer ceramic capacitor made from the particles of claim 1.
